(19) United States
(12) Patent Application Publication
(10) Pub. No.: US 2026/0367784 A1
(43) Pub. Date: Nov. 19, 2026

(54) CONFIGURABLE THERMAL MANAGEMENT PER CUSTOMER IN MEMORY SYSTEM

(71) Applicant: Micron Technology, Inc., Boise, ID (US)

(72) Inventors: John E. Maroney, Irvine, CA (US); Pedro Cordon, Irvine, CA (US); Henry H. Torabi, Irvine, CA (US)

(21) Appl. No.: 19/646,382

(22) Filed: Apr. 13, 2026

Related U.S. Application Data
(60) Provisional application No. 63/806,373, filed on May 15, 2025.

(51) Int. Cl. G06F 3/06

(52) U.S. Cl. CPC G06F 3/0604; G06F 3/0653; G06F 3/0679

(57) ABSTRACT

Methods, systems, and devices for configurable thermal management per customer are described. A memory system may perform a thermal management procedure according to a granular throttling scheme that is tuned to the memory system. During a first duration, the memory system may operate one or more memory devices as part of a throttling procedure for thermal management of one or more memory devices. The memory system may operate the one or more memory devices according to a first throttling mode if a thermal state of the one or more memory devices satisfies a first threshold. The first threshold may be based on a set of throttling values including an initial throttling value and a delta throttling value for thermal management. In response to a change in the thermal state, the memory system may operate the one or more memory devices according to a second throttling mode.

### CROSS REFERENCE

The present application for patent claims priority to U.S. Patent Application No. 63/806,373 by Maroney et al., entitled “CONFIGURABLE THERMAL MANAGEMENT PER CUSTOMER IN MEMORY SYSTEM,” filed May 15, 2025, which is assigned to the assignee hereof, and which is expressly incorporated by reference in its entirety herein.

### TECHNICAL FIELD

The following relates to one or more systems for memory, including configurable thermal management per customer.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not- or (NOR) and not- and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports configurable thermal management per customer in accordance with examples as disclosed herein.

FIG. 2 shows an example of an architecture that supports configurable thermal management per customer in accordance with examples as disclosed herein.

FIG. 3 shows an example of a throttling diagram that supports configurable thermal management per customer in accordance with examples as disclosed herein.

FIG. 4 shows a block diagram of a memory system that supports configurable thermal management per customer in accordance with examples as disclosed herein.

FIGS. 5 and 6 show flowcharts illustrating a method or methods that support configurable thermal management per customer in accordance with examples as disclosed herein.

### DETAILED DESCRIPTION

Some memory systems may be designed with one or more thermal management solutions to cool a subsystem or one or more components within the memory system, such as a ball grid array (BGA), in an effort to prevent or otherwise mitigate reduced performance of the memory system due to relatively high temperatures of the memory system. In some examples, a memory system (e.g., a solid state drive (SSD)) may perform thermal management in a similar way (e.g., using similar temperature thresholds to trigger throttling) irrespective of how the memory system is used or other environmental parameters associated with the memory system. For example, if a thermal management solution of a memory system does not completement (e.g., augment or otherwise align with) a cooling solution of the memory system (e.g., one or more heat sink thresholds), the memory system may fail to meet adequate performance metrics when the memory system operates above a threshold temperature range.

Techniques described herein may provide for a memory system to perform thermal management according to a relatively granular throttling scheme that is tuned to the memory system. That is, the memory system may be configured, such as during manufacture and testing of the memory system, with temperature thresholds for various thermal throttling states of the memory system, where the temperature thresholds and corresponding power states may be tuned according to a use case and type of the memory system (e.g., per customer and stock keeping unit (SKU)). For example, during a first duration, the memory system may operate according to a first throttling mode if a first thermal state of one or more memory devices within the memory system satisfies a first threshold (e.g., a first temperature). The first throttling mode may be associated with a first pulse width modulation (PWM) duty cycle, a first processing or clocking speed, or a first power consumption level, and/or the like. The memory system may be configured with a set of throttling values, including at least a first (e.g., an initial) throttling value and a second (e.g., delta) throttling value, for thermal management, where the throttling values are tuned based on the memory system type and use case and the first threshold may be based on the throttling values.

The memory system may monitor, while operating, a thermal state of the memory system using one or more thermal sensors within the memory system. If the thermal state transitions from the first thermal state to a second thermal state (e.g., a temperature change), the memory system may compare the second thermal state with the first threshold and a second threshold based on the throttling values. If the second thermal state fails to satisfy the first threshold and satisfies the second threshold, the memory system may switch to a second thermal state associated with a second PWM power state duty cycle, a second processing or clock speed, or a second power consumption level, and/or the like. The memory system described herein may thereby transition between thermal throttling states according to changes in operating temperature as compared with various thermal thresholds. By configuring the thermal thresholds according to operating parameters of the memory system, the memory system may ensure that a power consumption and clock speed of the system at a given time will provide for improved performance in view of a temperature of the memory system, which may improve reliability and a lifetime of the memory system, among other examples.

In addition to applicability in memory systems as described herein, techniques for configurable thermal management per customer may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by controlling operations performed by a device in response to temperature changes at the device, which may allow a device to re-enter a normal operation state without causing long term damage to the device, thus improving reliability. These techniques may also tune a throttling profile of each customer device individually without affecting a firmware image, among other benefits.

In addition to applicability in memory systems as described herein, techniques for configurable thermal management per customer may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by throttling a device's functions and operations based on a temperature of the device on a per-customer basis, which may extend the life of electronic devices and thereby may reduce electronic waste, among other benefits.

Features of the disclosure are illustrated and described in the context of systems, devices, and circuits. Features of the disclosure are further illustrated and described in the context of an architecture, a throttling diagram, and flowcharts.

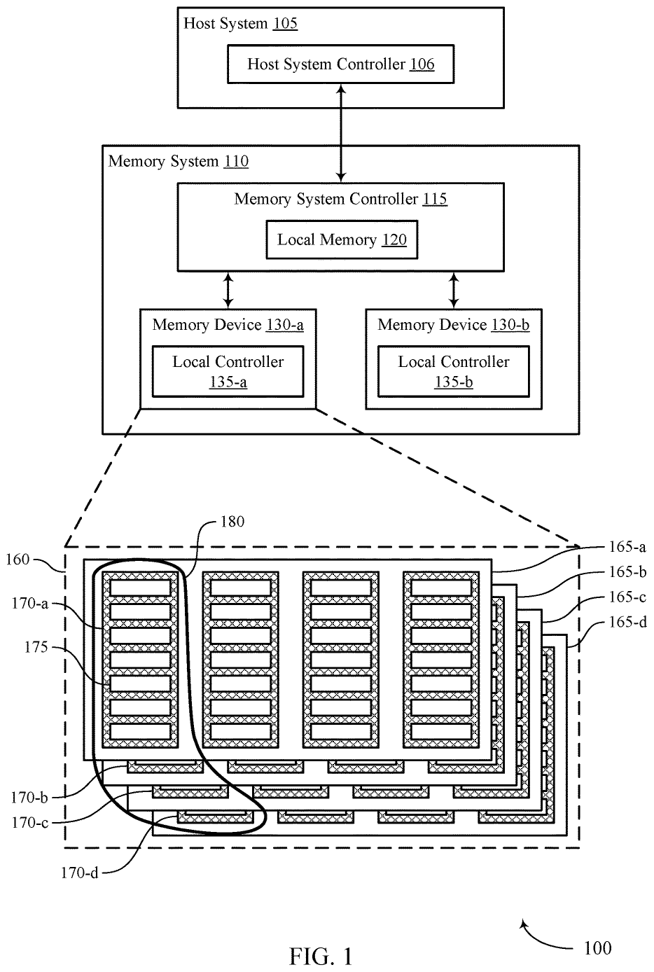

FIG. 1 shows an example of a system 100 that supports configurable thermal management per customer in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

Some systems (e.g., automotive systems) may have different thermal management solutions to cool a BGA to inhibit or prevent thermal performance throttling and shutdown. However, a memory system may generally (e.g., always) perform thermal throttling and protection using a same method or process (e.g., without regard to a thermal management solution of a particular automotive system) to throttle and shut down the memory system in response to temperature changes exceeding one or more thresholds. That is, the memory system may fail to account for system-specific parameters that may affect operation at the memory system (e.g., failing to adjust operations based on the system-specific parameters. This may present some problems if a first thermal management solution (e.g., corresponding to a first customer) does not adequately align with a cooling solution to achieve a full performance over an operating temperature range. Some memory systems may perform thermal management using a same method, regardless of a customer's system thermal management solution (e.g., without regard to thermal management procedures executed by a customer device). In some examples, a host system may send one or more management commands (e.g., non-volatile memory express (NVMe) host controlled thermal management (HCTM) commands) to a memory system to set either of two thresholds (e.g., TMT1 or TMT2 thresholds). Setting either of the two thresholds may lower or raise thermal throttling setpoints for the memory system, allowing a user (e.g., customer) to customize the memory system thermal throttling behavior (e.g., to match one or more components associated with a customer or an SKU).

Accordingly, techniques described herein support a thermal management procedure of an SSD, tuned for a thermal management cooling solution (e.g., of a customer) to provide for improved performance without thermal throttling relatively frequently or in scenarios where thermal throttling may provide for relatively large decreases in system performance without associated sizes of gains in terms of temperature reduction. For example, a memory system 110 may perform a thermal management procedure according to a granular throttling scheme that is tuned to the memory system 110. For example, during a first duration, the memory system 110 may operate one or more memory devices 130 as part of a throttling procedure for thermal management of one or more memory devices 130 within the memory system 110. The memory system 110 may operate the one or more memory devices 130 according to a first throttling mode if a first thermal state of the one or more memory devices 130 satisfies a first threshold. The memory system 110 may be configured with a set of throttling values including at least an initial throttling value and a delta throttling value for thermal management. The first threshold may be based on the set of throttling values. While operating the one or more memory devices 130, the memory system 110 may monitor a thermal state of the memory system 110 using one or more thermal sensors within the memory system 110. During this monitoring, the thermal state may transition from the first thermal state to a second thermal state (e.g., a temperature change). In response, and during a second duration, the memory system 110 may operate the one or more memory devices 130 according to a second throttling mode if the second thermal state fails to satisfy the first threshold and if the second thermal state satisfies a second threshold that is based on the set of throttling values.

As described herein, the term “thermal state” may refer to a temperature (e.g., a composite temperature) of a device such as a memory system 110. For example, a thermal state may include an aggregate temperature of one or more components of the memory system 110 (e.g., one or more memory devices 130, one or more memory system controllers 115). Similarly, “thermal management” may refer to managing (e.g., lowering or raising) a temperature of the one or more components of the memory system 110 (e.g., by changing one or more operation parameters to cool the memory system 110).

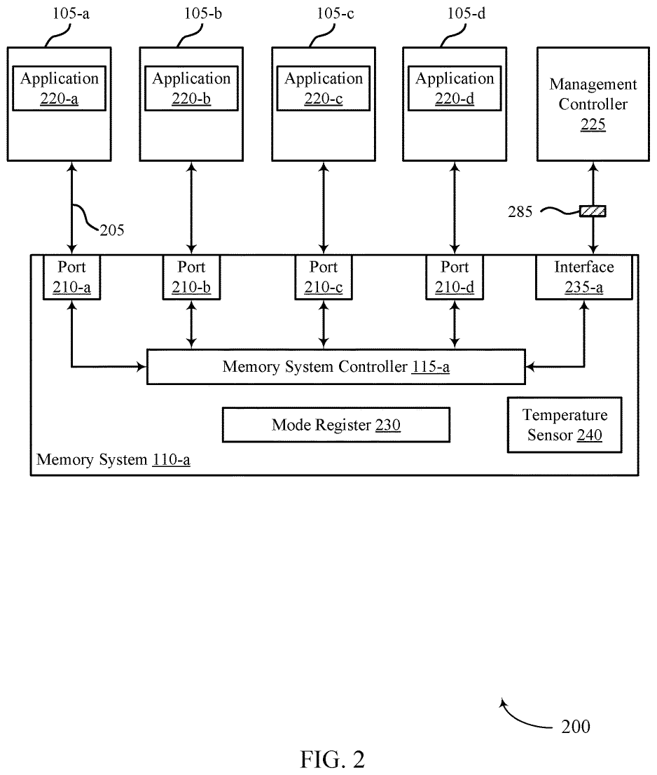

FIG. 2 shows an example of an architecture 200 that supports configurable thermal management per customer in accordance with examples as disclosed herein. One or more aspects of the architecture 200 may implement or may be implemented by one or more aspects of the system 100. For example, the architecture 200 may include a host system 105-a, a host system 105-b, a host system 105-c, a host system 105-d, and a memory system 110-a with a memory system controller 115-a and a mode register 230, which may be examples of corresponding devices or systems described herein. In some cases, the architecture 200 may be implemented in or as part of an automotive system, and architecture 200 may support increased performance, reliability, and sustainability for memory systems included within the automative system as described herein.

For example, memory system 110-a may be a multi-ported memory system and may include a port 210-a, a port 210-b, a port 210-c, and a port 210-d. The ports 210 may allow for multiple host systems 105 to establish connections with the memory system 110-a and to execute commands using the memory system 110-a for executing applications 220 (e.g., or functions). For example, a host system 105-a may be coupled with the memory system 110-a via the port 210-a and may host (e.g., and may execute commands for) an application 220-a. A host system 105-b may be coupled with the memory system 110-a via the port 210-b and may host an application 220-b, a host system 105-c may be coupled with the memory system via the memory system 110-a via the port 210-c and may host an application 220-c, and a host system 105-d may be coupled with the memory system 110-a via the port 210-d and may host an application 220-d. In some examples, each port 210 may operate independently. For example, each port 210 may involve different link speeds (e.g., PCIe link speeds) or may be reset independently. Further, the ports 210 may operate simultaneously or concurrently, or at different times. In some cases, boot partitions, replay protected memory blocks (RPMBs), virtualization (e.g., single root I/O virtualization (SRIOV)), and resource allocation may also be per port.

Although the architecture 200 illustrates four host systems 105 and four ports 210, it is to be understood that a memory system may include any quantity and combination of ports and host systems, including four of each, or any other quantities. The memory system 110-a may include one or more memory arrays across one or more memory devices that store data for the execution of the various applications. The ports may provide an interface for communicating commands and data with the host systems 105, but the actual data for each host system 105 may be stored in various locations within the memory system 110-a.

In some examples, the host systems 105 may transmit commands (e.g., in-band commands) that are associated with execution of an application 220. The host systems 105 may be controlled by or may include one or more components or systems of an automotive platform, and applications 220 may support one or more functions of the automotive platform or some other type of platform. Such commands may be communicated to the memory system 110-a via a peripheral component interconnect (PCI) interface 205 between a host system 105 and a port 210 of the memory system 110-a, which may be referred to as an in-band channel. The host systems 105 may communicate with the memory system 110-a using the ports 210 via in-band signaling (e.g., via a PCIe bus) which may differ from out-of-band (OOB) signaling, as the PCI interface 205 may support transfer of data and commands, while one or more OOB channels may not be used for data transfer, but may instead be used for transfer of metadata and other management commands. Commands sent by a host system 105 may cause or instruct the memory system controller 115-a to execute operations and/or access memory (e.g., at one or more memory devices 130 of the memory system 110-a). The commands may be NVMe commands, or some other type of command.

In some examples, the memory system 110-a may include an interface 235-a (e.g., a management port) which may be used for managing one or more aspects of the memory system 110-a. In some cases, the memory system 110-a may use the interface 235-a for thermal management and device throttling. For example, the memory system 110-a may receive, from a management controller 225, a message 285 including one or more configurations for thermal management via the interface 235-a. In some implementations, the memory system 110-a may control (e.g., throttle) operations at each port 210 based on a thermal state of the memory system 110-a. The message 285 may indicate one or more thermal thresholds (e.g., temperature thresholds) and one or more throttling procedures to perform at each port 210 (e.g., the one or more configurations). In some cases, by throttling operations based on a thermal state, a multi-ported memory system 110-a may have a longer device life and increased overall performance, when compared with other memory systems.

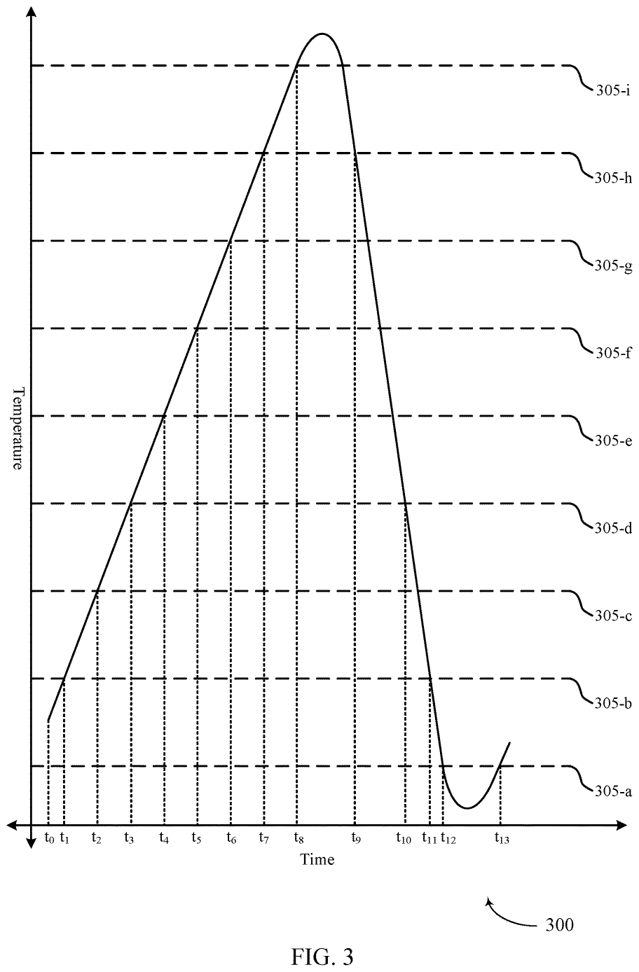

The architecture 200 may support a multi-ported memory system 110-a that performs a thermal management procedure according to a granular throttling scheme that is tuned to the multi-ported memory system 110-a. For example, during a first duration, the multi-ported memory system 110-a may operate one or more memory devices 130 as part of a throttling procedure for thermal management of one or more memory devices 130 within the multi-ported memory system 110-a. The multi-ported memory system 110-a may operate the one or more memory devices 130 according to a first throttling mode (or a first set of throttling operations) if a first thermal state (e.g., temperature) of the one or more memory devices 130 satisfies a first threshold. The multi-ported memory system 110-a may be configured with a set of throttling values including at least an initial throttling value and a delta throttling value for thermal management. The first threshold may be based on the set of throttling values. While operating the one or more memory devices 130, the multi-ported memory system 110-a may monitor a thermal state of the multi-ported memory system 110-a using one or more thermal sensors within the multi-ported memory system 110-a. During this monitoring, the thermal state may transition from the first thermal state to a second thermal state (e.g., a temperature change). In response, and during a second duration, the multi-ported memory system 110-a may operate the one or more memory devices 130 according to a second throttling mode (or a second set of throttling operations) if the second thermal state fails to satisfy the first threshold and if the second thermal state satisfies a second threshold that is based on the set of throttling values. In response to the thermal state satisfying a third threshold, the multi-ported memory system 110-a may operate the one or more memory devices 130 according to a third throttling mode. Accordingly, the memory system 110-a may dynamically switch between a set of throttling modes (e.g., as described herein with reference to FIG. 3) based on the thermal state and one or more thresholds.

In some examples, the multi-ported memory system 110-a may store data for applications associated with relatively high reliability and performance requirements, such as a vehicle or other automated system. In such cases, throttling operations in response to temperature changes may reduce a likelihood of system failure and electronic waste. The thermal state (e.g., temperature) of the memory system 110-a may be measured by one or more temperature sensors 240 included within the memory system 110-a, the memory system controller 115-a, each memory device within the memory system 110-a, or any combination thereof. Techniques for configurable thermal management and throttling are described in further detail elsewhere herein, including with reference to FIG. 3.

FIG. 3 shows an example of a throttling diagram 300 that supports configurable thermal management per customer in accordance with examples as disclosed herein. The throttling diagram 300 may implement or be implemented by some aspects of the system 100, the architecture 200, or both. For example, a memory system 110 (e.g., a multi-ported memory system 110-a) may perform a throttling procedure according to the throttling diagram 300 (e.g., in response to changes in temperature of the memory system 110). That is, the throttling diagram 300 may illustrate the throttling procedure performed by the memory system 110 as a thermal state of the memory system 110 changes.

The throttling diagram 300 includes an x-axis representing time and a y-axis representing temperature of the memory system 110. The throttling diagram 300 also includes a set of thresholds 305 (e.g., threshold temperatures), including a threshold 305-a, a threshold 305-b, a threshold 305-c, a threshold 305-d, a threshold 305-e, a threshold 305-f, a threshold 305-g, a threshold 305-h, and a threshold 305-i. In some cases, the throttling diagram 300 may illustrate a thermal state of one or more memory systems (e.g., an automotive system) over some duration of operation of the memory system and may illustrate how the one or more memory systems may operate or adjust operations in response to changes in the thermal state. Accordingly, the throttling diagram 300 may illustrate how techniques described herein may support increased performance, reliability, and sustainability for memory systems included within the automative system as described herein.

In some implementations, the throttling diagram 300 may support configurable thermal management per customer and stock keeping unit (SKU) control core functions. As described herein, an SKU may refer to an identifier or a value associated with a particular manufacturer or customer of the memory system 110 (e.g., a certain product type). For example, the memory system 110 may be configured with (e.g., deployed with) an initial value (e.g., a first or initial throttling setpoint) for thermal management in accordance with an SKU associated with the memory system 110. Accordingly, the memory system 110 may support customizing the initial value (e.g., the first throttling setpoint) to a system heatsink regulation point (e.g., extending a reliability of the memory system 110). That is, the initial value may correspond to a designed temperature threshold on one or more heat sinks within the memory system 110 (e.g., a temperature at which the one or more heat sinks may take action to cool down components in the memory system 110). In some cases, the memory system 110 may have a configured delta value (e.g., a delta rise) of a controller (e.g., a memory system controller 115) in accordance with the SKU associated with the memory system 110. The delta value may be a maximum permitted change in temperature of the controller relative to a component temperature of the memory system 110 (e.g., a NAND temperature). Configuring the delta value as such may allow for more accurate thermal management for composite thermal regulation within the memory system 110. Lowering the delta value may provide for the controller's temperature to control thermal regulation. For example, by reducing a maximum permitted difference between the controller temperature and one or more component temperatures, the controller of the memory system 110 may account for an on-die controller thermal sensor location relative to locations of the components (e.g., NAND die locations) and relative to average temperature deltas. The set of throttling values, including the initial throttling value and the delta throttling value, may be configured in storage by one or more manufacturers (e.g., per SKU) for tuning thermal regulation to different customer control schemas.

A composite temperature of the memory system 110 (e.g., composite temperature of an SSD) may be based on temperatures of a set of memory devices 130 of the memory system 110, such as a NAND temperature and a DRAM temperature (e.g., corresponding to a NAND and a DRAM providing storage for the memory system 110). The memory system 110 may perform thermal regulation to protect the set of memory devices 130 from thermal transients. The memory system 110 may calculate the composite temperature (e.g., composite self-monitoring, analysis, and reporting technology (SMART) temperature) using an aggregate temperature of the memory system 110 (e.g., the SSD). For example, the memory system 110 may calculate the composite temperature using some or all component temperatures corresponding to component devices of the memory system 110.

In some examples, the memory system 110 may calculate the composite temperature (e.g., T_{composite}) based on one or more temperatures associated with the memory system 110. The one or more temperatures may include a memory controller temperature (e.g., T junction controller offset (T_{jcont_off})) and a memory device (e.g., NAND) temperature (e.g., T junction NAND valid (T_{jNAND_valid}). In some cases, the composite temperature may be calculated as the greater (e.g., the maximum) or the lesser (e.g., the minimum) of the memory controller temperature and the memory device temperature based on one or more factors. For example, a configuration may indicate whether the memory system 110 is to select the greater or the lesser of the two temperatures (e.g., according to a customization of a user or customer).

T_{jcont_off}=T_{S}−T_{delta} (1)

In some implementations, the memory system 110 may calculate the memory controller temperature (e.g., T_{jcont_off}) according to formula (1), where T_{S} is a temperature recorded by a sensor at the memory system controller 115 and T_{delta} is an offset stored in manufacturing data per SKU (e.g., the delta value). For example, T_{delta} may be configurable at a manufacturing time of the memory system 110 (e.g., by a manufacturer of the memory system 110). In some cases, the memory system 110 may store the T_{delta} value in manufacturing data during a one or more manufacturing procedures of the memory system 110. In some examples, the T_{delta} may be a difference between the temperature recorded by the sensor and a composite temperature (e.g., an actual temperature) of the memory system 110 (e.g., at a time of manufacture). In some cases, if the memory controller temperature satisfies a threshold (e.g., if the temperature exceeds 20 °C), the memory system 110 may select a greater value of the memory controller temperature and the memory device temperature. Additionally, or alternatively, the memory system 110 may select a lesser value of the memory controller temperature and the memory device temperature if the memory controller temperature fails to satisfy the threshold (e.g., if the temperature is less than or equal to 20 °C).

In some implementations, if the temperature recorded by a sensor at the memory system controller 115 is less than zero (e.g., 0° Celsius), the memory system 110 may calculate the memory controller temperature based on T_{delta}, T_{S}, or both. For example, if −T_{delta}<T_{S}<0, the memory system 110 may calculate the memory controller temperature as T_{jcont_off}=−T_{delta}. Additionally, or alternatively, if T_{S}≤−T_{delta}, the memory system 110 may calculate the memory controller temperature as T_{jcont_off}=T_{S}.

The memory system 110 may calculate the memory device temperature (e.g., T_{jNAND_valid}) by aggregating temperatures recorded by temperature sensors at each die of the memory system 110 (e.g., {DIE1, DIE2, . . . , DIEn}). If temperature sensors on one or more dies of the memory system 110 report a temperature that satisfies a threshold relative to the memory controller temperature (e.g., T_{jcont_off}), the memory system 110 may mark the one or more dies invalid, and accordingly may calculate the memory system temperature without accounting for the temperature of those one or more invalid dies. For example, the memory system 110 may mark a die invalid if a temperature sensor of the die indicates that the difference between the temperature reported by the temperature sensor and the memory controller temperature satisfies (e.g., exceeds) a threshold (e.g., 20 °C).

In some cases, the memory system 110 may sample temperatures (e.g., via temperature sensors on one or more dies, on a memory system controller 115, or the like) at a first sampling rate. That is, the memory system 110 may calculate the temperatures according to the first sampling rate (e.g., 1 second polling, or sampling every 1 second) prior to the composite temperature of the memory system 110 satisfying a pre-throttle threshold (e.g., the threshold 305-b). In response to the composite temperature satisfying (e.g., exceeding) the pre-throttle threshold, the memory system 110 may sample the temperatures according to a second sampling rate that is higher than the first sampling rate. For example, the memory system 110 may calculate the temperatures at a rate twice as fast after the pre-throttle threshold is satisfied (e.g., 500 millisecond polling, or sampling every 500 milliseconds). In response to the composite temperature satisfying a first throttle threshold (e.g., the threshold 305-c, or TMT1), the memory system 110 may sample the temperatures according to a third sample rate that is higher than the first sampling rate, the second sampling rate, or both. For example, the memory system 110 may perform temperature samples at one or more components of the memory system 110 at an accelerated rate after crossing the first throttle threshold (e.g., 150 millisecond polling, or sampling every 150 milliseconds).

In some implementations, the initial value and the delta value may be configurable per capacity SKU (e.g., in a set of memory cells corresponding to manufacturing data). Manufacturing data may be set or configured during one or more manufacturing processes (e.g., for each customer). Accordingly, including the initial value and the delta value in manufacturing data may not affect a single firmware binary image. Instead, the firmware may be the same across multiple memory systems 110, and the firmware may retrieve the initial value and the delta value as device settings or system settings (e.g., default settings) at boot time (e.g., automatically). In some cases, the memory system 110 may receive configuration data, including the initial value and the delta value, via an in-band PCIe interface, a system management bus (SMBus) interface, a universal asynchronous receiver or transmitter (UART) interface, or any combination thereof.

In some implementations, a manufacturer may perform a thermal simulation procedure on a testing device (e.g., a second memory system 110 or another device that is used as a tester for multiple memory systems 110 having the same SKU and/or customers and use case) to determine values for calculating the set of thresholds 305. For example, based on the thermal simulation procedure, the testing device may determine and store an initial throttling value associated with a regulation point (e.g., a heatsink regulation point) of the memory system 110. The initial throttling value may indicate an initial temperature (e.g., threshold) associated with a first throttling mode of the memory system 110. Similarly, based on the thermal simulation procedure, the testing device may determine and store a delta throttling value (e.g., T_{delta}) associated with a difference between a first temperature at one or more controllers (e.g., memory system controllers 115) of the memory system 110 and a second temperature at one or more memory devices 130 within the memory system 110 and coupled with the one or more controllers. The initial throttling value and the delta throttling value may be associated with thermal management of the memory system 110. In some cases, the testing device may generate a set of throttling values (e.g., including the initial throttling value and the delta throttling value) based on an SKU of the memory system 110. Additionally, or alternatively, the set of throttling values may be applicable to a set of second memory systems 110 associated with the SKU. The values calculated during testing may be deployed to the testing device and the one or more other memory systems 110 associated with the SKU and/or similar customers and use cases to use during operations.

In some implementations, the memory system 110 may perform one or more thermal management procedures based on the set of values (e.g., the initial throttling value and the delta throttling value). For example, at time to, the memory system 110 may operate according to an initial mode (e.g., operating one or more memory devices 130 of the memory system 110 according to a resume or a normal mode, without throttling). The memory system 110 may operate according to the initial mode if a temperature (e.g., thermal state) of the memory system 110 satisfies one or more thresholds (e.g., if the temperature is below the threshold 305-c and is above the threshold 305-a).

While operating in the initial mode, the memory system 110 may operate in accordance with a first set of clock frequencies including a first processing clock frequency and a first system clock frequency. For example, in the initial mode, one or more processing components associated with the memory system 110 (e.g., one or more central processing units (CPUs)) may operate according to the first processing clock frequency (e.g., a CPU clocking frequency such as 700 MHz). Similarly, the memory system 110 may operate according to the first system clock frequency (e.g., a system clocking frequency such as 280 MHz). In some cases, the memory system 110 may operate according to an initial duty cycle of a PWM while in the initial mode. As described herein, a PWM may have or may correspond to a duty cycle (e.g., an “on-to-off” ratio) associated with a clock cycle of the memory system 110. For example, “PWM=80%” may indicate that an “on” duration of the clock cycle spans 80% of the clock cycle while an “off” duration of the clock cycle spans 20% of the clock cycle. The PWM may have or may be associated with multiple duty cycles. As described herein the term “PWM” may refer to a power state modulation from a high power state (e.g., an L0 PCIe link state) to a low power state (e.g., an L1.0 PCIe link state).

The memory system 110 may monitor a thermal state (e.g., temperature) of the memory system 110 during operation. In the example of FIG. 3, at time t₁, the memory system 110 may detect that the thermal state satisfies (e.g., meets or exceeds) the threshold 305-b (e.g., a pre-throttling threshold). In response, the memory system 110 may begin to monitor or calculate the thermal state with greater frequency. At time t₂, the memory system 110 may detect that the thermal state satisfies the threshold 305-c (e.g., TMT1, “tmt1_th”). In response, the memory system 110 may transition to a first throttling mode. That is, the memory system 110 may operate according to the first throttling mode based on the thermal state satisfying the threshold 305-c (e.g., and failing to satisfy the threshold 305-d). In some cases, while in the first throttling mode, the memory system 110 may operate according to a first duty cycle of the PWM that is less than the initial duty cycle (e.g., such that PWM=70%).

While operating according to the first throttling mode, the memory system 110 may operate in accordance with different sets of clock frequencies based on an operational state of the memory system 110. For example, in a first operational state (e.g., a “high” state or an “L0” link state), the memory system 110 may operate in accordance with the first set of clock frequencies including the first processing clock frequency and the first system clock frequency. In a second operational state (e.g., a “low” state, an “L1.0” link state, or an “idle” mode), the memory system 110 may operate in accordance with a second set of clock frequencies including a second processing clock frequency and a second system clock frequency. For example, in the first throttling mode, and in the second operational state, one or more processing components (e.g., CPUs) associated with the memory system 110 may operate according to the second processing clock frequency (e.g., a CPU clocking frequency such as 25 MHz). Similarly, the memory system 110 may operate according to the second system clock frequency (e.g., a system clocking frequency such as 25 MHz). The second processing clock frequency may be less than the first processing clock frequency and the second system clock frequency may be less than the first system clock frequency. In some implementations, while operating according to the first throttling mode, the memory system 110 may operate in accordance with a range of clock frequencies between the first set of clock frequencies and the second set of clock frequencies (e.g., based on the memory system 110 operating according to one or more third operational states).

At time t₃, the memory system 110 may detect that the thermal state satisfies (e.g., meets or exceeds) the threshold 305-d (e.g., TMT2, “tmt2_th”). In response, the memory system 110 may transition to a second throttling mode. That is, the memory system 110 may operate according to the second throttling mode based on the thermal state satisfying the threshold 305-d (and failing to satisfy the threshold 305-e). In some cases, while in the second throttling mode, the memory system 110 may operate according to a second duty cycle of the PWM that is less than the first duty cycle (e.g., such that PWM=50%). While operating according to the second throttling mode, the memory system 110 may operate in accordance with a set of clock frequencies that is based on an operational state of the memory system 110 (e.g., as with the first throttling mode). The second throttling mode may be based on the thermal state failing to satisfy the threshold 305-e and based on the second thermal state satisfying the threshold 305-d that is based on the set of throttling values.

At time t₄, the memory system 110 may detect that the thermal state satisfies the threshold 305-e (e.g., TMT3, “tmt3_th”). In response, the memory system 110 may transition to a third throttling mode. That is, the memory system 110 may operate according to the third throttling mode based on the thermal state satisfying the threshold 305-e (and failing to satisfy the threshold 305-f). In some cases, while in the third throttling mode, the memory system 110 may operate according to a third duty cycle of the PWM that is less than the second duty cycle (e.g., such that PWM=25%). While operating according to the third throttling mode, the memory system 110 may operate in accordance with a set of clock frequencies that is based on an operational state of the memory system 110 (e.g., as with the first throttling mode).

At time t₅, the memory system 110 may detect that the thermal state satisfies the threshold 305-f (e.g., an “Extreme Throttle” threshold, “extreme_th”). In response, the memory system 110 may transition to a fourth throttling mode. That is, the memory system 110 may operate according to the fourth throttling mode based on the thermal state satisfying the threshold 305-f (and failing to satisfy the threshold 305-g). In some cases, while in the fourth throttling mode, the memory system 110 may operate according to a fourth duty cycle of the PWM that is less than the third duty cycle (e.g., such that PWM=15%). While operating according to the fourth throttling mode, the memory system 110 may operate in accordance with a set of clock frequencies that is based on an operational state of the memory system 110 (e.g., as with the first throttling mode).

At time to, the memory system 110 may detect that the thermal state satisfies the threshold 305-g (e.g., a “Trickle Mode” threshold, “trickle_th”). In response, the memory system 110 may transition to a fifth throttling mode. That is, the memory system 110 may operate according to the fifth throttling mode based on the thermal state satisfying the threshold 305-g (and failing to satisfy the threshold 305-h). In some cases, while in the fifth throttling mode, the memory system 110 may operate according to a fifth duty cycle of the PWM that is less than the fourth duty cycle (e.g., such that PWM=5%). While operating according to the fifth throttling mode, the memory system 110 may operate in accordance with a set of clock frequencies that is based on an operational state of the memory system 110 (e.g., as with the first throttling mode).

At time t₇, the memory system 110 may detect that the thermal state satisfies the threshold 305-h (e.g., a “Hot Abort” threshold, “hot_abort_th”). In response, the memory system 110 may transition to a sixth throttling mode. That is, the memory system 110 may operate according to the sixth throttling mode based on the thermal state satisfying the threshold 305-h (and failing to satisfy the threshold 305-i). In some cases, while in the sixth throttling mode, the memory system 110 may operate according to a sixth duty cycle of the PWM that is less than the fifth duty cycle (e.g., such that PWM=0%). While operating according to the sixth throttling mode, the memory system 110 may operate in accordance with the second set of clock frequencies (e.g., clock frequencies corresponding to an “idle” mode). That is, one or more processing components (e.g., CPUs) associated with the memory system 110 may operate according to the second processing clock frequency (e.g., a CPU clocking frequency such as 25 MHz). Similarly, the memory system 110 may operate according to the second system clock frequency (e.g., a system clocking frequency such as 25 MHz). In response to the thermal state satisfying the threshold 305-h, the memory system 110 may abort commands (e.g., all NVMe commands) that have a particular namespace (e.g., namespace “not ready). Further, the memory system 110 may stop performing one or more background jobs.

At time t₈, the memory system 110 may detect that the thermal state satisfies the threshold 305-i (e.g., a “Shutdown” threshold, “shutdown_th”). In response, the memory system 110 may transition to a seventh throttling mode. That is, the memory system 110 may operate according to the seventh throttling mode based on the thermal state satisfying the threshold 305-i. In some cases, while in the seventh throttling mode, the memory system 110 may operate according to the sixth duty cycle. While operating according to the seventh throttling mode, the memory system 110 may operate in accordance with the second set of clock frequencies (e.g., as with the sixth throttling mode). In response to the thermal state satisfying the threshold 305-i, the memory system 110 may abort all commands of one or more types (e.g., NVMe commands). Further, the memory system 110 may stop performing further background jobs (e.g., garbage collection, block family error avoidance, or the like).

The memory system 110 may continue to monitor the thermal state after time t₈. However, the memory system 110 may refrain from exiting the seventh throttling mode until the thermal state drops below (e.g., fails to satisfy) the threshold 305-h (e.g., the threshold associated with the sixth throttling mode) at time to. That is, at time to, the memory system 110 may transition to the sixth throttling mode. Accordingly, as the thermal state drops (e.g., as the temperature of the memory system 110 drops), the memory system 110 may respond by transitioning to the fifth throttling mode in response to the thermal state dropping below the threshold 305-g, transitioning to the fourth throttling mode in response to the thermal state dropping below the threshold 305-f, transitioning to the third throttling mode in response to the thermal state dropping below the threshold 305-e, transitioning to the second throttling mode in response to the thermal state dropping below the threshold 305-d (e.g., at time t₁₀), and transitioning to the first throttling mode in response to the thermal state dropping below the threshold 305-c. At time t₁₁, in response to the thermal state dropping below the threshold 305-b, the memory system 110 may operate according to the initial state as described herein.

At time t₈, the memory system 110 may detect that the thermal state drops below the threshold 305-a (e.g., a “Cold Abort” threshold, “cold_abort_th”). In response, the memory system 110 may transition to an eighth throttling mode. That is, the memory system 110 may operate according to the eighth throttling mode based on the thermal state satisfying the threshold 305-i. In some cases, while in the eighth throttling mode, the memory system 110 may operate according to the sixth duty cycle. While operating according to the eighth throttling mode, the memory system 110 may operate in accordance with the second set of clock frequencies (e.g., as with the sixth throttling mode). In response to the thermal state dropping below the threshold 305-a, the memory system 110 may abort commands (e.g., all NVMe commands) that have a particular namespace (e.g., namespace “not ready). Further, the memory system 110 may stop performing one or more background jobs (e.g., similarly to the sixth throttling mode).

TABLE 1A

| | | | | | |
|---|---|---|---|---|---|
| Performance | 100.00% | 70.00% | 50.00% | 25.00% | 12.50% |
| % relative | | | | | |
| to full power | | | | | |
| Throttling | Pre-throttling | TMT1 | TMT2 | TMT3 | Extreme |
| Mode | | | | | |
| Entry | >=I_throttle_p − | >=I_throttle_p | >=I_throttle_p + | >=I_throttle_p + 4 | >=I_throttle_p + |
| Threshold | 13 | | 2 | | 6 |
| Temperature | | | | | |
| (°C) | | | | | |
| Entry | >=I_throttle_p − | >=I_throttle_p + | >=I_throttle_p + | >=I_throttle_p + | >=I_throttle_p + |
| Threshold | 13 + 273.15 | 273.15 | 2 + 273.15 | 4 + 273.15 | 6 + 273.15 |
| Temperature | | | | | |
| (K) | | | | | |
| Exit | <I_throttle_p − | <I_throttle_p − | <I_throttle_p | <I_throttle_p + | <I_throttle_p + |
| Threshold | 15 | 2 | | 2 | 4 |
| Temperature | | | | | |
| (°C) | | | | | |

TABLE 1B

| | | | | |
|---|---|---|---|---|
| Performance % | 5.0% | | | |
| relative to full | | | | |
| power | | | | |
| Throttling Mode | Trickle | Abort | Shutdown | Max rating |
| Entry Threshold | >=I_throttle_p + | >=I_throttle_p + | >=I_throttle_p + | 130 |
| Temperature (°C) | 8 | 10 | 12 | |
| Entry Threshold | >=I_throttle_p + | >=I_throttle_p + | >=I_throttle_p + | 403.15 |
| Temperature (K) | 8 + 273.15 | 10 + 273.15 | 12 + 273.15 | |
| Exit Threshold | <I_throttle_p + | <I_throttle_p + | <I_throttle_p + | <I_throttle_p + |
| Temperature (°C) | 4 | 6 | 8 | 10 |

Tables 1A and 1B illustrate examples of throttling thresholds and performance levels for some of the example throttling modes as described herein. For example, in the throttling mode “Trickle” (e.g., the fifth throttling mode), the memory system 110 may operate according to a performance level of 5% relative to a full power capability of the memory system 110 (e.g., relative to a power capability used in the “pre-throttling” mode or the initial mode). The throttling mode “Trickle” may correspond to an entry threshold temperature (e.g., a temperature at which the memory system 110 may enter the throttling mode) equal to the initial throttling value (e.g., I_throttle_p) plus some offset (e.g., 8 °C). Entry threshold temperatures are also provided in Kelvin. Similarly, the throttling mode “Trickle” may correspond to an exit threshold temperature (e.g., a temperature at which the memory system 110 may exit the throttling mode) equal to the initial throttling value plus a second offset (e.g., 4 °C).

In some implementations, the memory system 110 may support setting the initial throttling value and the delta throttling value on a per-die-capacity basis (e.g., in manufacturing data). That is, initial and delta throttling values may be independently settable for each die capacity supported by the memory system 110. For example, a first die capacity (e.g., 4×DIE) may correspond with a first initial throttling value and a first delta throttling value, a second die capacity (e.g., 8×DIE) may correspond with a second initial throttling value and a second delta throttling value, and so on. In some cases, the initial and delta throttling values may be stored as values in degrees Celsius or in units Kelvin.

Techniques described herein may support a configuration of an initial throttle setpoint and a delta offset setpoint. Supporting such a configuration may allow for tuning a thermal throttling profile of a memory system 110 to a particular cooling system (e.g., on a per-customer basis or a per-SKU basis) without affecting a firmware image. That is, by flexibly tuning the various thresholds 305 per memory system usage scenarios (e.g., during a per-SKU testing operation), the manufacturer may deploy many different memory systems having a same firmware system that perform effective cooling and thermal throttling operations across many different use cases, which may reduce costs and complexity as compared with systems in which the thermal throttling does not account for cooling operations (e.g., heat sink thresholds) for the memory system or other memory system-specific parameters. Accordingly, configuring a thermal profile of a memory system 110 may allow the memory system 110 to increase reliability by limiting damaging temperatures. Additionally, although nine thresholds 305 and thermal throttling states are illustrated and described with reference to FIG. 3, it is to be understood that a memory system 110 may be configured with any quantity of thresholds 305 and corresponding thermal throttling states, including any of the thresholds 305 and example throttling states described herein, any other thresholds 305 and throttling states, or any combination thereof.

The described techniques thereby provide for configurable thermal thresholds 305 and corresponding throttling states, defined by various clock frequency and PWM parameters to granularly reduce power consumption according to a temperature of the memory system 110 during operation.

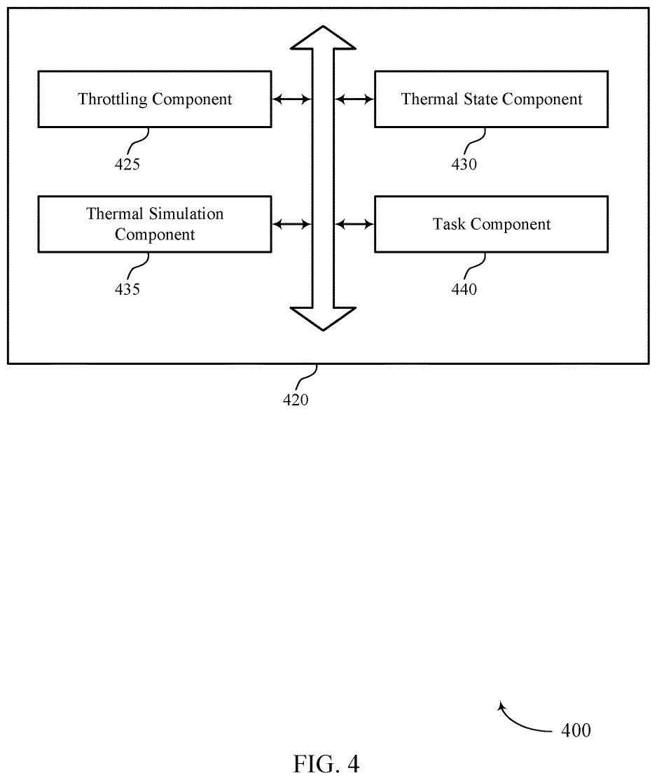

FIG. 4 shows a block diagram 400 of a memory system 420 that supports configurable thermal management per customer in accordance with examples as disclosed herein. The memory system 420 may be an example of aspects of a memory system as described with reference to FIGS. 1 through 3. The memory system 420, or various components thereof, may be an example of means for performing various aspects of configurable thermal management per customer as described herein. For example, the memory system 420 may include a throttling component 425, a thermal state component 430, a thermal simulation component 435, a task component 440, or any combination thereof. Each of these components, or components of subcomponents thereof (e.g., one or more processors, one or more memories), may communicate, directly or indirectly, with one another (e.g., via one or more buses). In some examples, the t

The throttling component 425 may be configured as or otherwise support a means for operating, during a first duration and as part of a throttling procedure for thermal management of one or more memory devices within a memory system, the one or more memory devices according to a first throttling mode based at least in part on a first thermal state of the one or more memory devices satisfying a first threshold, the first threshold based at least in part on a set of throttling values for the memory system, the set of throttling values including at least an initial throttling value and a delta throttling value for thermal management. The thermal state component 430 may be configured as or otherwise support a means for monitoring a thermal state of the memory system, where the thermal state transitions from the first thermal state to a second thermal state of the one or more memory devices. In some examples, the throttling component 425 may be configured as or otherwise support a means for operating, during a second duration and as part of the throttling procedure, the one or more memory devices according to a second throttling mode based at least in part on the second thermal state failing to satisfy the first threshold and based at least in part on the second thermal state satisfying a second threshold that is based at least in part on the set of throttling values.

In some examples, to support operating the one or more memory devices according to the second throttling mode, the throttling component 425 may be configured as or otherwise support a means for operating the one or more memory devices in accordance with a pulse width modulation power supply having a second duty cycle that is less than a first duty cycle of the pulse width modulation power supply.

In some examples, the throttling component 425 may be configured as or otherwise support a means for operating, during a third duration and in response to the thermal state transitioning from the second thermal state to a third thermal state, the one or more memory devices according to a third throttling mode based at least in part on the third thermal state failing to satisfy the second threshold and based at least in part on the third thermal state satisfying a third threshold that is based at least in part on the set of throttling values, where the third throttling mode is associated with operation in accordance with a third duty cycle of the pulse width modulation power supply that is less than the second duty cycle.

In some examples, the throttling component 425 may be configured as or otherwise support a means for operating, during a fourth duration and in response to the thermal state transitioning from the second thermal state to a fourth thermal state, the one or more memory devices according to a fourth throttling mode based at least in part on the fourth thermal state failing to satisfy the second threshold and based at least in part on the fourth thermal state satisfying a fourth threshold that is based at least in part on the set of throttling values. In some examples, the task component 440 may be configured as or otherwise support a means for terminating one or more tasks within the memory system based at least in part on operating the one or more memory devices according to the fourth throttling mode, where the one or more tasks include one or more background jobs, one or more non-volatile memory express commands, or any combination thereof within the memory system.

In some examples, the set of throttling values is based at least in part on a thermal simulation procedure for the memory system.

In some examples, the initial throttling value indicates an initial temperature associated with the first throttling mode. In some examples, the first threshold is based at least in part on the initial throttling value. In some examples, the delta throttling value is associated with a difference between a first temperature at one or more controllers of the memory system and a second temperature at the one or more memory devices of the memory system. In some examples, the thermal state of the memory system is based at least in part on the delta throttling value.

In some examples, the throttling component 425 may be configured as or otherwise support a means for retrieving, after transitioning from a first power state to a second power state associated with higher power than the first power state, the set of throttling values from for a storage location for storage of manufacturing data for the memory system.

In some examples, the memory system is associated with a stock keeping unit. In some examples, the set of throttling values is associated with the stock keeping unit of the memory system.

In some examples, the throttling component 425 may be configured as or otherwise support a means for receiving, via one or more interfaces of the memory system, configuration data that indicates the set of throttling values, where the one or more interfaces include an in-band peripheral component interconnect express interface, a system management bus interface, a universal asynchronous receiver or transmitter interface, or any combination thereof. In some examples, the throttling component 425 may be configured as or otherwise support a means for storing the set of throttling values in response to receiving the configuration data.

In some examples, the thermal state of the memory system includes a maximum value from among a set of values including a first value and a second value based at least in part on the first value satisfying a threshold temperature, the first value based at least in part on a difference between a first temperature at one or more controllers of the memory system and the delta throttling value and the second value based at least in part on a second temperature at the one or more memory devices of the memory system.

In some examples, the thermal state of the memory system includes a minimum value from among a set of values including a first value and a second value based at least in part on the first value failing to satisfy a threshold temperature, the first value based at least in part on a difference between a first temperature at one or more controllers of the memory system and the delta throttling value and the second value based at least in part on a second temperature at the one or more memory devices of the memory system.

The thermal simulation component 435 may be configured as or otherwise support a means for performing a thermal simulation procedure associated with a memory system including multiple ports. The throttling component 425 may be configured as or otherwise support a means for storing, based at least in part on the thermal simulation procedure, an initial throttling value associated with a regulation point of the memory system, where the initial throttling value indicates an initial temperature associated with a first throttling mode of the memory system. In some examples, the throttling component 425 may be configured as or otherwise support a means for storing, based at least in part on the thermal simulation procedure, a delta throttling value associated with a difference between a first temperature at one or more controllers of the memory system and a second temperature at one or more memory devices within the memory system and coupled with the one or more controllers, where the initial throttling value and the delta throttling value are associated with thermal management of the memory system.

In some examples, to support storing the initial throttling value and the delta throttling value, the throttling component 425 may be configured as or otherwise support a means for storing a set of throttling values including at least the initial throttling value and the delta throttling value for thermal management within a storage location of the memory system associated with manufacturing data.

In some examples, the throttling component 425 may be configured as or otherwise support a means for generating a set of throttling values including the initial throttling value and the delta throttling value based at least in part on a stock keeping unit of the memory system, where the set of throttling values is applicable to a plurality of second memory systems associated with the stock keeping unit.

In some examples, the regulation point includes a heatsink regulation point of the memory system.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

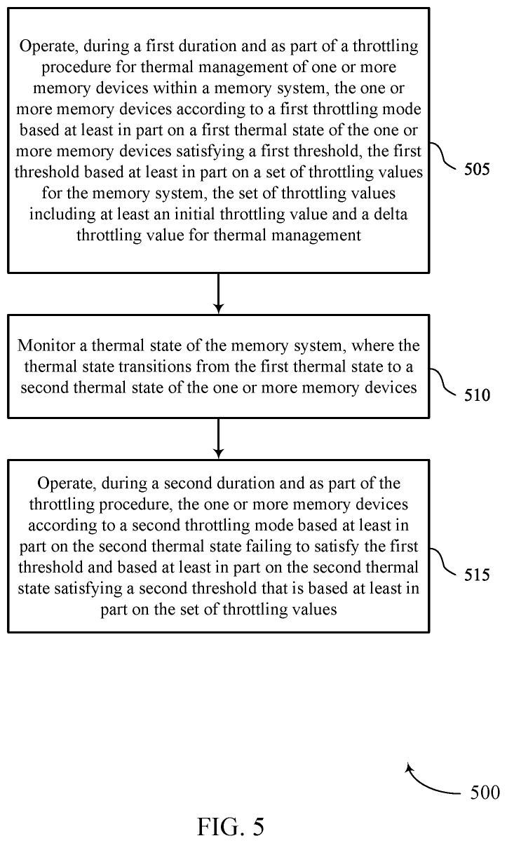

FIG. 5 shows a flowchart illustrating a method 500 that supports configurable thermal management per customer in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include operating, during a first duration and as part of a throttling procedure for thermal management of one or more memory devices within a memory system, the one or more memory devices according to a first throttling mode based at least in part on a first thermal state of the one or more memory devices satisfying a first threshold, the first threshold based at least in part on a set of throttling values for the memory system, the set of throttling values including at least an initial throttling value and a delta throttling value for thermal management. In some examples, aspects of the operations of 505 may be performed by a throttling component 425 as described with reference to FIG. 4.

At 510, the method may include monitoring a thermal state of the memory system, where the thermal state transitions from the first thermal state to a second thermal state of the one or more memory devices. In some examples, aspects of the operations of 510 may be performed by a thermal state component 430 as described with reference to FIG. 4.

At 515, the method may include operating, during a second duration and as part of the throttling procedure, the one or more memory devices according to a second throttling mode based at least in part on the second thermal state failing to satisfy the first threshold and based at least in part on the second thermal state satisfying a second threshold that is based at least in part on the set of throttling values. In some examples, aspects of the operations of 515 may be performed by a throttling component 425 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for operating, during a first duration and as part of a throttling procedure for thermal management of one or more memory devices within a memory system, the one or more memory devices according to a first throttling mode based at least in part on a first thermal state of the one or more memory devices satisfying a first threshold, the first threshold based at least in part on a set of throttling values for the memory system, the set of throttling values including at least an initial throttling value and a delta throttling value for thermal management; monitoring a thermal state of the memory system, where the thermal state transitions from the first thermal state to a second thermal state of the one or more memory devices; and operating, during a second duration and as part of the throttling procedure, the one or more memory devices according to a second throttling mode based at least in part on the second thermal state failing to satisfy the first threshold and based at least in part on the second thermal state satisfying a second threshold that is based at least in part on the set of throttling values.

Aspect 2: The method, apparatus, or non-transitory computer-readable medium of aspect 1, where operating the one or more memory devices according to the second throttling mode includes operations, features, circuitry, logic, means, or instructions, or any combination thereof for operating the one or more memory devices in accordance with a pulse width modulation power supply having a second duty cycle that is less than a first duty cycle of the pulse width modulation power supply.

Aspect 3: The method, apparatus, or non-transitory computer-readable medium of aspect 2, further including operations, features, circuitry, logic, means, or instructions, or any combination thereof for operating, during a third duration and in response to the thermal state transitioning from the second thermal state to a third thermal state, the one or more memory devices according to a third throttling mode based at least in part on the third thermal state failing to satisfy the second threshold and based at least in part on the third thermal state satisfying a third threshold that is based at least in part on the set of throttling values, where the third throttling mode is associated with operation in accordance with a third duty cycle of the pulse width modulation power supply that is less than the second duty cycle.

Aspect 4: The method, apparatus, or non-transitory computer-readable medium of any of aspects 1 through 3, further including operations, features, circuitry, logic, means, or instructions, or any combination thereof for operating, during a fourth duration and in response to the thermal state transitioning from the second thermal state to a fourth thermal state, the one or more memory devices according to a fourth throttling mode based at least in part on the fourth thermal state failing to satisfy the second threshold and based at least in part on the fourth thermal state satisfying a fourth threshold that is based at least in part on the set of throttling values and terminating one or more tasks within the memory system based at least in part on operating the one or more memory devices according to the fourth throttling mode, where the one or more tasks include one or more background jobs, one or more non-volatile memory express commands, or any combination thereof within the memory system.

Aspect 5: The method, apparatus, or non-transitory computer-readable medium of any of aspects 1 through 4, where the set of throttling values is based at least in part on a thermal simulation procedure for the memory system.

Aspect 6: The method, apparatus, or non-transitory computer-readable medium of any of aspects 1 through 5, where the initial throttling value indicates an initial temperature associated with the first throttling mode; the first threshold is based at least in part on the initial throttling value; the delta throttling value is associated with a difference between a first temperature at one or more controllers of the memory system and a second temperature at the one or more memory devices of the memory system; and the thermal state of the memory system is based at least in part on the delta throttling value.

Aspect 7: The method, apparatus, or non-transitory computer-readable medium of any of aspects 1 through 6, further including operations, features, circuitry, logic, means, or instructions, or any combination thereof for retrieving, after transitioning from a first power state to a second power state associated with higher power than the first power state, the set of throttling values from for a storage location for storage of manufacturing data for the memory system.

Aspect 8: The method, apparatus, or non-transitory computer-readable medium of any of aspects 1 through 7, where the memory system is associated with a stock keeping unit and the set of throttling values is associated with the stock keeping unit of the memory system.

Aspect 9: The method, apparatus, or non-transitory computer-readable medium of any of aspects 1 through 8, further including operations, features, circuitry, logic, means, or instructions, or any combination thereof for receiving, via one or more interfaces of the memory system, configuration data that indicates the set of throttling values, where the one or more interfaces include an in-band peripheral component interconnect express interface, a system management bus interface, a universal asynchronous receiver or transmitter interface, or any combination thereof and storing the set of throttling values in response to receiving the configuration data.

Aspect 10: The method, apparatus, or non-transitory computer-readable medium of any of aspects 1 through 9, where the thermal state of the memory system includes a maximum value from among a set of values including a first value and a second value based at least in part on the first value satisfying a threshold temperature, the first value based at least in part on a difference between a first temperature at one or more controllers of the memory system and the delta throttling value and the second value based at least in part on a second temperature at the one or more memory devices of the memory system.

Aspect 11: The method, apparatus, or non-transitory computer-readable medium of any of aspects 1 through 10, where the thermal state of the memory system includes a minimum value from among a set of values including a first value and a second value based at least in part on the first value failing to satisfy a threshold temperature, the first value based at least in part on a difference between a first temperature at one or more controllers of the memory system and the delta throttling value and the second value based at least in part on a second temperature at the one or more memory devices of the memory system.

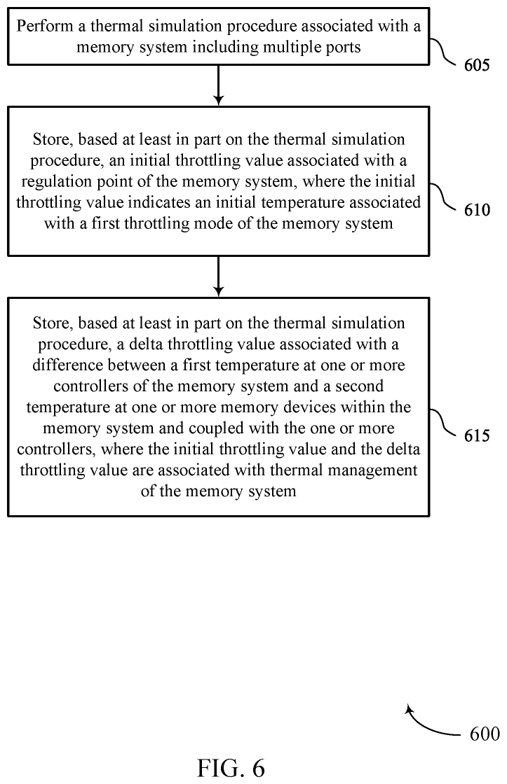

FIG. 6 shows a flowchart illustrating a method 600 that supports configurable thermal management per customer in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include performing a thermal simulation procedure associated with a memory system including multiple ports. In some examples, aspects of the operations of 605 may be performed by a thermal simulation component 435 as described with reference to FIG. 4.

At 610, the method may include storing, based at least in part on the thermal simulation procedure, an initial throttling value associated with a regulation point of the memory system, where the initial throttling value indicates an initial temperature associated with a first throttling mode of the memory system. In some examples, aspects of the operations of 610 may be performed by a throttling component 425 as described with reference to FIG. 4.

At 615, the method may include storing, based at least in part on the thermal simulation procedure, a delta throttling value associated with a difference between a first temperature at one or more controllers of the memory system and a second temperature at one or more memory devices within the memory system and coupled with the one or more controllers, where the initial throttling value and the delta throttling value are associated with thermal management of the memory system. In some examples, aspects of the operations of 615 may be performed by a throttling component 425 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 12: A method, apparatus, or non-transitory computer-readable medium including operations, features, circuitry, logic, means, or instructions, or any combination thereof for performing a thermal simulation procedure associated with a memory system including multiple ports; storing, based at least in part on the thermal simulation procedure, an initial throttling value associated with a regulation point of the memory system, where the initial throttling value indicates an initial temperature associated with a first throttling mode of the memory system; and storing, based at least in part on the thermal simulation procedure, a delta throttling value associated with a difference between a first temperature at one or more controllers of the memory system and a second temperature at one or more memory devices within the memory system and coupled with the one or more controllers, where the initial throttling value and the delta throttling value are associated with thermal management of the memory system.

Aspect 13: The method, apparatus, or non-transitory computer-readable medium of aspect 12, where storing the initial throttling value and the delta throttling value includes operations, features, circuitry, logic, means, or instructions, or any combination thereof for storing a set of throttling values including at least the initial throttling value and the delta throttling value for thermal management within a storage location of the memory system associated with manufacturing data.

Aspect 14: The method, apparatus, or non-transitory computer-readable medium of any of aspects 12 through 13, further including operations, features, circuitry, logic, means, or instructions, or any combination thereof for generating a set of throttling values including the initial throttling value and the delta throttling value based at least in part on a stock keeping unit of the memory system, where the set of throttling values is applicable to a plurality of second memory systems associated with the stock keeping unit.

Aspect 15: The method, apparatus, or non-transitory computer-readable medium of any of aspects 12 through 14, where the regulation point includes a heatsink regulation point of the memory system.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
operate, during a first duration and as part of a throttling procedure for thermal management of the one or more memory devices within the memory system, the one or more memory devices according to a first throttling mode based at least in part on a first thermal state of the one or more memory devices satisfying a first threshold, the first threshold based at least in part on a set of throttling values for the memory system, the set of throttling values comprising at least an initial throttling value and a delta throttling value for thermal management;
monitor a thermal state of the memory system, wherein the thermal state transitions from the first thermal state to a second thermal state of the one or more memory devices; and
operate, during a second duration and as part of the throttling procedure, the one or more memory devices according to a second throttling mode based at least in part on the second thermal state failing to satisfy the first threshold and based at least in part on the second thermal state satisfying a second threshold that is based at least in part on the set of throttling values.

2. The memory system of claim 1, wherein, to operate the one or more memory devices according to the second throttling mode, the processing circuitry is further configured to cause the memory system to:
operate the one or more memory devices in accordance with a pulse width modulation power supply having a second duty cycle that is less than a first duty cycle of the pulse width modulation power supply.

3. The memory system of claim 2, wherein the processing circuitry is further configured to cause the memory system to:
operate, during a third duration and in response to the thermal state transitioning from the second thermal state to a third thermal state, the one or more memory devices according to a third throttling mode based at least in part on the third thermal state failing to satisfy the second threshold and based at least in part on the third thermal state satisfying a third threshold that is based at least in part on the set of throttling values, wherein the third throttling mode is associated with operation in accordance with a third duty cycle of the pulse width modulation power supply that is less than the second duty cycle.

4. The memory system of claim 1, wherein the processing circuitry is further configured to cause the memory system to:
operate, during a fourth duration and in response to the thermal state transitioning from the second thermal state to a fourth thermal state, the one or more memory devices according to a fourth throttling mode based at least in part on the fourth thermal state failing to satisfy the second threshold and based at least in part on the fourth thermal state satisfying a fourth threshold that is based at least in part on the set of throttling values; and
terminate one or more tasks within the memory system based at least in part on operating the one or more memory devices according to the fourth throttling mode, wherein the one or more tasks comprise one or more background jobs, one or more non-volatile memory express commands, or any combination thereof within the memory system.

5. The memory system of claim 1, wherein the set of throttling values is based at least in part on a thermal simulation procedure for the memory system.

6. The memory system of claim 1, wherein:
the initial throttling value indicates an initial temperature associated with the first throttling mode,
the first threshold is based at least in part on the initial throttling value,
the delta throttling value is associated with a difference between a first temperature at one or more controllers of the memory system and a second temperature at the one or more memory devices of the memory system, and
the thermal state of the memory system is based at least in part on the delta throttling value.

7. The memory system of claim 1, wherein the processing circuitry is further configured to cause the memory system to:
retrieve, after transitioning from a first power state to a second power state associated with higher power than the first power state, the set of throttling values from for a storage location for storage of manufacturing data for the memory system.

8. The memory system of claim 1, wherein:
the memory system is associated with a stock keeping unit, and
the set of throttling values is associated with the stock keeping unit of the memory system.

9. The memory system of claim 1, wherein the processing circuitry is further configured to cause the memory system to:
receive, via one or more interfaces of the memory system, configuration data that indicates the set of throttling values, wherein the one or more interfaces comprise an in-band peripheral component interconnect express interface, a system management bus interface, a universal asynchronous receiver or transmitter interface, or any combination thereof; and
store the set of throttling values in response to receiving the configuration data.

10. The memory system of claim 1, wherein the thermal state of the memory system comprises a maximum value from among a set of values comprising a first value and a second value based at least in part on the first value satisfying a threshold temperature, the first value based at least in part on a difference between a first temperature at one or more controllers of the memory system and the delta throttling value and the second value based at least in part on a second temperature at the one or more memory devices of the memory system.

11. The memory system of claim 1, wherein the thermal state of the memory system comprises a minimum value from among a set of values comprising a first value and a second value based at least in part on the first value failing to satisfy a threshold temperature, the first value based at least in part on a difference between a first temperature at one or more controllers of the memory system and the delta throttling value and the second value based at least in part on a second temperature at the one or more memory devices of the memory system.

12. A memory system, comprising:
one or more memory devices; and
processing circuitry coupled with the one or more memory devices and configured to cause the memory system to:
perform a thermal simulation procedure associated with the memory system comprising multiple ports;
store, based at least in part on the thermal simulation procedure, an initial throttling value associated with a regulation point of the memory system, wherein the initial throttling value indicates an initial temperature associated with a first throttling mode of the memory system; and
store, based at least in part on the thermal simulation procedure, a delta throttling value associated with a difference between a first temperature at one or more controllers of the memory system and a second temperature at the one or more memory devices within the memory system and coupled with the one or more controllers, wherein the initial throttling value and the delta throttling value are associated with thermal management of the memory system.

13. The memory system of claim 12, wherein, to store the initial throttling value and the delta throttling value, the processing circuitry is further configured to cause the memory system to:
store a set of throttling values comprising at least the initial throttling value and the delta throttling value for thermal management within a storage location of the memory system associated with manufacturing data.

14. The memory system of claim 12, wherein the processing circuitry is further configured to cause the memory system to:
generate a set of throttling values comprising the initial throttling value and the delta throttling value based at least in part on a stock keeping unit of the memory system, wherein the set of throttling values is applicable to a plurality of second memory systems associated with the stock keeping unit.

15. The memory system of claim 12, wherein the regulation point comprises a heatsink regulation point of the memory system.

16. A method, comprising:
operating, during a first duration and as part of a throttling procedure for thermal management of one or more memory devices within a memory system, the one or more memory devices according to a first throttling mode based at least in part on a first thermal state of the one or more memory devices satisfying a first threshold, the first threshold based at least in part on a set of throttling values for the memory system, the set of throttling values comprising at least an initial throttling value and a delta throttling value for thermal management;
monitoring a thermal state of the memory system, wherein the thermal state transitions from the first thermal state to a second thermal state of the one or more memory devices; and
operating, during a second duration and as part of the throttling procedure, the one or more memory devices according to a second throttling mode based at least in part on the second thermal state failing to satisfy the first threshold and based at least in part on the second thermal state satisfying a second threshold that is based at least in part on the set of throttling values.

17. The method of claim 16, wherein operating the one or more memory devices according to the second throttling mode comprises:
operating the one or more memory devices in accordance with a pulse width modulation power supply having a second duty cycle that is less than a first duty cycle of the pulse width modulation power supply.

18. The method of claim 17, further comprising:
operating, during a third duration and in response to the thermal state transitioning from the second thermal state to a third thermal state, the one or more memory devices according to a third throttling mode based at least in part on the third thermal state failing to satisfy the second threshold and based at least in part on the third thermal state satisfying a third threshold that is based at least in part on the set of throttling values, wherein the third throttling mode is associated with operation in accordance with a third duty cycle of the pulse width modulation power supply that is less than the second duty cycle.

19. The method of claim 16, further comprising:
operating, during a fourth duration and in response to the thermal state transitioning from the second thermal state to a fourth thermal state, the one or more memory devices according to a fourth throttling mode based at least in part on the fourth thermal state failing to satisfy the second threshold and based at least in part on the fourth thermal state satisfying a fourth threshold that is based at least in part on the set of throttling values; and
terminating one or more tasks within the memory system based at least in part on operating the one or more memory devices according to the fourth throttling mode, wherein the one or more tasks comprise one or more background jobs, one or more non-volatile memory express commands, or any combination thereof within the memory system.

20. The method of claim 16, further comprising:
retrieving, after transitioning from a first power state to a second power state associated with higher power than the first power state, the set of throttling values from for a storage location for storage of manufacturing data for the memory system.

21. The method of claim 16, further comprising:
receiving, via one or more interfaces of the memory system, configuration data that indicates the set of throttling values, wherein the one or more interfaces comprise an in-band peripheral component interconnect express interface, a system management bus interface, a universal asynchronous receiver or transmitter interface, or any combination thereof; and
storing the set of throttling values in response to receiving the configuration data.

22. A method, comprising:
performing a thermal simulation procedure associated with a memory system comprising multiple ports;
storing, based at least in part on the thermal simulation procedure, an initial throttling value associated with a regulation point of the memory system, wherein the initial throttling value indicates an initial temperature associated with a first throttling mode of the memory system; and
storing, based at least in part on the thermal simulation procedure, a delta throttling value associated with a difference between a first temperature at one or more controllers of the memory system and a second temperature at one or more memory devices within the memory system and coupled with the one or more controllers, wherein the initial throttling value and the delta throttling value are associated with thermal management of the memory system.

23. The method of claim 22, wherein storing the initial throttling value and the delta throttling value comprises:
storing a set of throttling values comprising at least the initial throttling value and the delta throttling value for thermal management within a storage location of the memory system associated with manufacturing data.

24. The method of claim 22, further comprising:
generating a set of throttling values comprising the initial throttling value and the delta throttling value based at least in part on a stock keeping unit of the memory system, wherein the set of throttling values is applicable to a plurality of second memory systems associated with the stock keeping unit.

25. The method of claim 22, wherein the regulation point comprises a heatsink regulation point of the memory system.

26. A non-transitory computer-readable medium storing code comprising instructions which, when executed by one or more processors of a memory system, cause the memory system to:
operate, during a first duration and as part of a throttling procedure for thermal management of one or more memory devices within the memory system, the one or more memory devices according to a first throttling mode based at least in part on a first thermal state of the one or more memory devices satisfying a first threshold, the first threshold based at least in part on a set of throttling values for the memory system, the set of throttling values comprising at least an initial throttling value and a delta throttling value for thermal management;
monitor a thermal state of the memory system, wherein the thermal state transitions from the first thermal state to a second thermal state of the one or more memory devices; and
operate, during a second duration and as part of the throttling procedure, the one or more memory devices according to a second throttling mode based at least in part on the second thermal state failing to satisfy the first threshold and based at least in part on the second thermal state satisfying a second threshold that is based at least in part on the set of throttling values.

27. The non-transitory computer-readable medium of claim 26, wherein the instructions to operate the one or more memory devices according to the second throttling mode, when executed by the one or more processors of the memory system, cause the memory system to:
operate the one or more memory devices in accordance with a pulse width modulation power supply having a second duty cycle that is less than a first duty cycle of the pulse width modulation power supply.

28. The non-transitory computer-readable medium of claim 27, wherein the instructions, when executed by the one or more processors of the memory system, further cause the memory system to:
operate, during a third duration and in response to the thermal state transitioning from the second thermal state to a third thermal state, the one or more memory devices according to a third throttling mode based at least in part on the third thermal state failing to satisfy the second threshold and based at least in part on the third thermal state satisfying a third threshold that is based at least in part on the set of throttling values, wherein the third throttling mode is associated with operation in accordance with a third duty cycle of the pulse width modulation power supply that is less than the second duty cycle.

29. The non-transitory computer-readable medium of claim 26, wherein the instructions, when executed by the one or more processors of the memory system, further cause the memory system to:
operate, during a fourth duration and in response to the thermal state transitioning from the second thermal state to a fourth thermal state, the one or more memory devices according to a fourth throttling mode based at least in part on the fourth thermal state failing to satisfy the second threshold and based at least in part on the fourth thermal state satisfying a fourth threshold that is based at least in part on the set of throttling values; and
terminate one or more tasks within the memory system based at least in part on operating the one or more memory devices according to the fourth throttling mode, wherein the one or more tasks comprise one or more background jobs, one or more non-volatile memory express commands, or any combination thereof within the memory system.

30. The non-transitory computer-readable medium of claim 26, wherein the instructions, when executed by the one or more processors of the memory system, further cause the memory system to:
retrieve, after transitioning from a first power state to a second power state associated with higher power than the first power state, the set of throttling values from for a storage location for storage of manufacturing data for the memory system.
